(19) United States
(12) Patent Application Publication
(10) Pub. No.: US 2024/0400313 A1
(43) Pub. Date: Dec. 5, 2024

(54) CONVEYOR ASSEMBLY

(71) Applicants: Gary David WALSH, Casuarina (AU); Michael Charles MCELLIGOTT, Hope Island (AU)

(72) Inventors: Gary David WALSH, Casuarina (AU); Michael Charles MCELLIGOTT, Hope Island (AU)

(21) Appl. No.: 18/677,539

(22) Filed: May 29, 2024

(30) Foreign Application Priority Data
May 30, 2023 (AU) 2023901700

(51) Int. Cl. B65G 23/20; B65G 17/06

(52) U.S. Cl. CPC B65G 23/20; B65G 17/061

(57) ABSTRACT

The conveyor assembly includes an elongate frame to which a looped conveyor track is mounted. The frame has a longitudinal direction, and the conveyor track is movable along the longitudinal direction. The conveyor track includes spaced engagement device. The conveyor assembly also includes a drive assembly with a drive shaft carrying a drive screw with a helical drive formation. The drive shaft and the drive screw are oriented parallel to the longitudinal direction of the frame, the helical drive formation being for engaging the spaced engagement device of the conveyor track.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a conveyor assembly.

### 2. Description of Related Art Including Information Disclosed Under 37 CFR 1.97 and 37 CFR 1.98

U.S. Pat. No. 11,365,060 B2, entitled “Conveyor Module, Assembly, System, and Control,” issued to Michael C. McElligott on Jun. 21, 2022, is incorporated by reference herein.

The US patent describes a narrow independently-driven belt module which provides low-profile, space-efficient conveyorization. These modules can be placed side-by-side to create various configurations. The patent did not address any novel drive system and is subject to the limitations of currently available drive systems as described below.

Conveyors are typically coupled to a “parallel shaft drive system”, so named due to the direction of motion of the driving components being parallel to the direction of conveyor belt travel. These drive systems are usually located beside the conveyor and include the motor and different drive mechanisms like gears, chains, or timing belt drive trains. This limits the width of the main body's conveyor belt in order to provide the space needed to accommodate this drive system.

Another limitation is the bulkiness of these said “parallel shaft drive systems,” which require certain arrangements of drive sprockets and idler pulleys that dictate the minimum height profile of conveyors.

The transfer of rotational power from a driving source to a desired linear travel output is critical in many industrial and commercial applications. Traditionally, sprockets and pulleys have transferred rotational power through chains or belts. However, these systems have several limitations, including the need for continuous tension and alignment, belt stretch, difficulty accommodating direction changes, and a limited ability to absorb shock and vibrations. These bulky solutions are also restricted from using on any low-profile applications.

In recent years, there has been a growing demand for more flexible and efficient solutions for transferring rotational power. As a result, numerous attempts have been made to develop alternative drive systems to address these challenges, including using gear reducers to convert rotational torque into linear travel. However, these solutions often have limitations and inefficiencies, such as high costs, complexity, and decreased durability.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### BRIEF SUMMARY OF THE INVENTION

According to a first aspect, the present invention provides a conveyor assembly comprising:
an elongate frame to which a looped conveyor track is mounted, the frame having a longitudinal direction, the conveyor track movable along the longitudinal direction and comprising spaced engagement means,
a drive assembly comprising a drive shaft carrying a drive screw with a helical drive formation, the drive shaft and the drive screw being oriented parallel to the longitudinal direction of the frame, the helical drive formation being for engaging the spaced engagement means of the conveyor track. In one embodiment, the lower engagement means comprises evenly spaced parallel rods.

In one embodiment, the track comprises an upper surface and the spaced engagement means comprises evenly spaced parallel rods disposed below the upper surface of the conveyor track.

In another embodiment, the track is formed by linked segments which are joined in series to form the looped track.

In another embodiment, each segment comprises an elongated body which extends laterally between side edges of the frame, the body including a flat upper surface, a leading edge, a trailing edge and side edges, the leading edge of including first coupling means, and the trailing edge including second coupling means to join with first coupling means of an adjacent trailing segment.

In another embodiment, the first coupling means comprises at least one rod which extends parallel to the lateral direction of the body.

In another embodiment, the first coupling means includes a central rod which defines the lower engagement means of the track.

In another embodiment, the first coupling means includes two side rods at either side of the central rod.

In another embodiment, the second coupling means comprises at least one trailing tab which corresponds and hingedly attaches with the rod of the leading edge.

In another embodiment, each segment comprises a central portion and wing portions extending laterally outwards from the central portion, the wing portions to rest on and slide along low friction side panels of the frame.

In another embodiment, the frame includes end plates with elongate shaped rail sections extending therebetween, the rail sections having upper low-friction side panels along side edges of the frame.

In another embodiment, the drive assembly comprises a motor driving a drive shaft, the drive shaft carrying at least one drive screw which has a helical groove formed at an outer surface, wherein the drive screw engages the spaced engagement means of the track.

In another embodiment, the spaced engagement means comprises angled spaced projections, portions of a gear formation, or portions of a helical thread to engage the helical drive formation of the drive assembly.

In another embodiment, the track comprises lateral edges, and the spaced engagement means comprises evenly spaced rollers or cam followers disposed adjacent at least one of the lateral edges.

In this embodiment, the track preferably includes spaced formations at its lower portion, the spaced formations being shaped to receive a respective connecting rod having the roller or cam follower at an outer end thereof.

In this embodiment, the drive shaft and the drive screw are preferably disposed above the spaced engagement means at an upper portion of the conveyor track.

The present invention provides a novel solution for transferring rotational power through a linked belt design. The linked belt design, driven with a spiral worm drive, offers significant advantages over traditional sprocket and pulley systems and alternative drive systems by providing a flexible and efficient means of transferring rotational power. This linked belt design is a versatile and innovative solution that has the potential to revolutionise the way rotational energy is transmitted in a variety of applications. Other aspects of the invention are also disclosed.

### BRIEF DESCRIPTION OF THE SEVERAL VIEWS OF THE DRAWINGS

Notwithstanding any other forms which may fall within the scope of the present invention, preferred embodiments of the present invention will now be described, by way of examples only, with reference to the accompanying drawings.

FIG. 1 is a front perspective view of side by side conveyor assemblies in accordance with a preferred embodiment of the present invention, the conveyor track of three assemblies being partly removed for illustration purposes.

FIG. 2 is a close-up perspective view of the conveyor assembly with one segment of the conveyor track.

FIG. 3 is a zoomed out perspective view of FIG. 2.

FIG. 4 is a side elevation view of the conveyor assembly with the housing omitted for illustration purposes.

FIG. 5 is an end elevation view of the conveyor assembly.

FIG. 6 shows a bottom perspective view of a section of another embodiment of the conveyor track.

FIG. 7 shows (a) front perspective view and (b) rear perspective view of a segment of the conveyor track of FIG. 6.

FIG. 8 is a perspective view of a section of another embodiment of the conveyor track with an alternative drive assembly placement.

FIG. 9 is a side view of FIG. 8.

FIG. 10 is an end view of FIG. 8.

### DETAILED DESCRIPTION OF THE INVENTION

It should be noted in the following description that like or the same reference numerals in different embodiments denote the same or similar features.

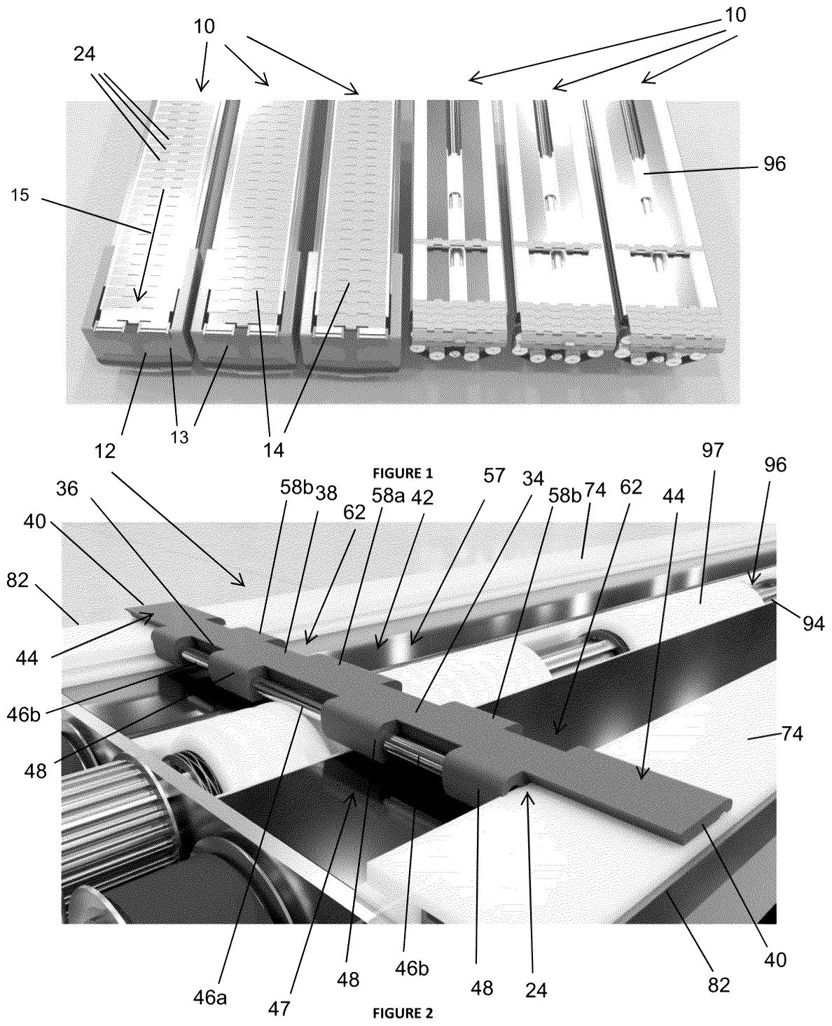

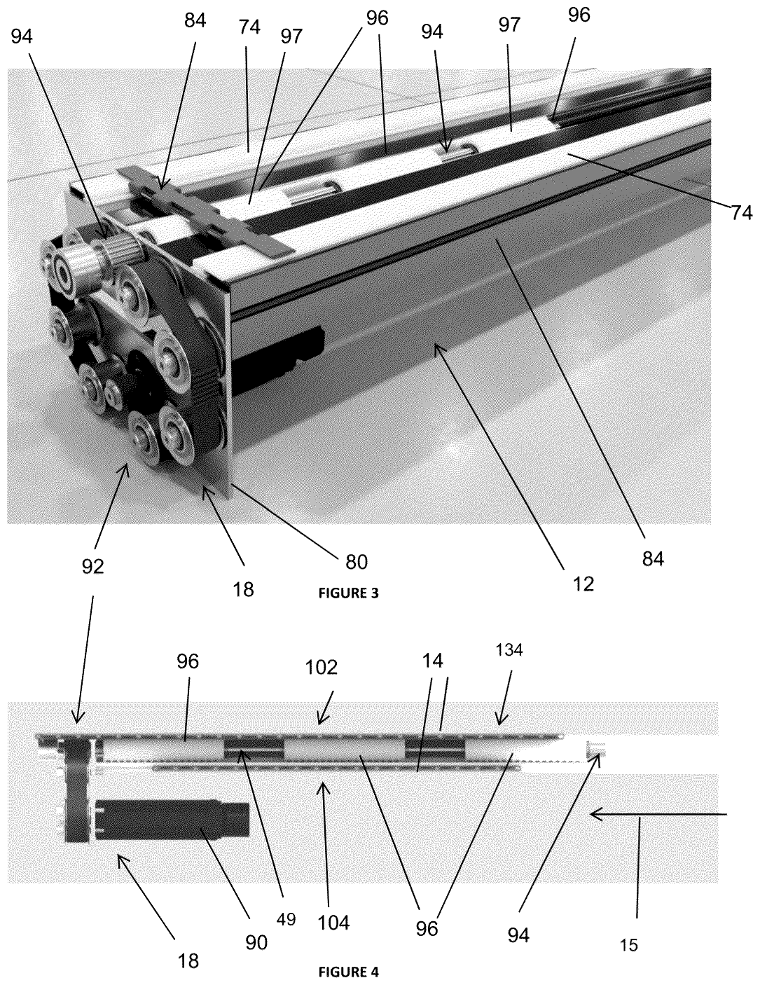

FIGS. 1 to 5 show a conveyor assembly 10 according to a preferred embodiment of the present invention. The conveyor assembly 10 comprises an elongate frame 12 having a longitudinal direction 15 to which a looped conveyor track 14 is mounted. The travel of the track 14 is along the longitudinal direction 15 between ends 13 of the elongate frame 12. The track 14 is formed by linked segments 24 which are joined in series to form the looped track 14. The conveyor assembly 10 also includes a drive assembly 18 for driving the track 14.

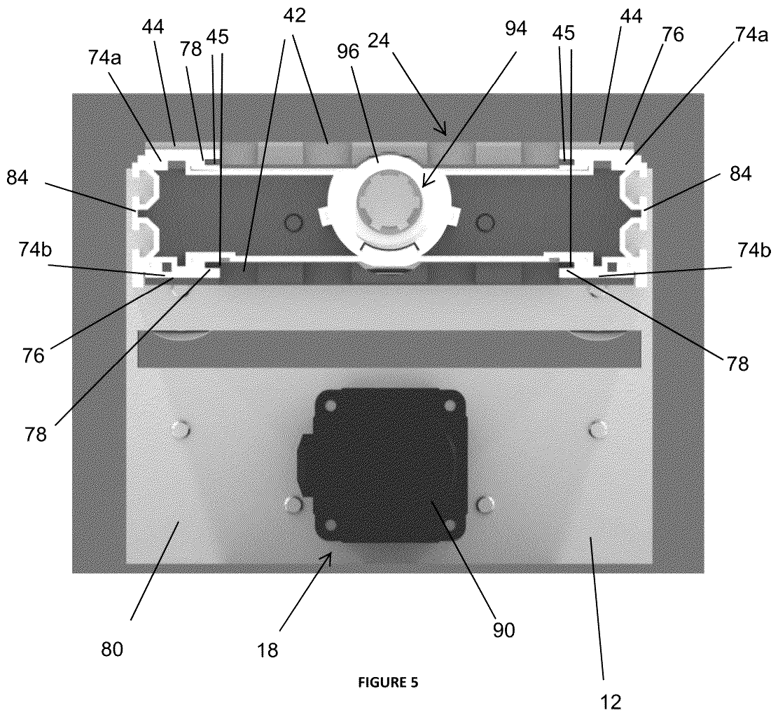

Each segment 24 comprises an elongated body which extends laterally between side edges 82 of the frame 12. The body 32 includes a flat upper surface 34, a leading edge 36, a trailing edge 38 and side edges 40 which are disposed adjacent to the side edges 82 of the frame 12. The segment 24 comprises a central portion 42 and wing portions 44 extending laterally outwards from the central portion 42. The wing portions 44 are generally flat extensions extending from the central portion 42 and which are to rest on and slide along low friction side panels 74 of the frame 12. The central portion 42 and the wing portions 44 together define the flat upper surface 34. As shown in FIG. 5, the central portion 42 also includes retainer tabs 45 extending laterally outwards thereof, the retainer tabs 45 being spaced below the wing portions 44.

The leading edge 36 of the central portion 14 includes spaced first coupling means 47 being spaced rods 46 which extend parallel to the lateral direction of the body 32. The rods 46 include a central rod 46a and two side rods 46b at either side of the central rod 46a. The rods 46 are held by spaced leading projections 48 of the central portion 42. The rods 46 can be separate rod sections or can be a single piece rod held by the leading projections 48.

The trailing edge 38 of the central portion 14 includes spaced second coupling means 57 being spaced trailing tabs 58 which are dimensioned and disposed to correspond and align with the rods 46 of the leading edge 36. Thus, in the embodiment shown, the trailing tabs 58 include a central tab 58a and two side tabs 58b. Each tab 58 includes a lower channel (not shown) for receiving and engaging a corresponding rod 46 therein.

Recesses 62 are formed in the trailing edge 38 between the tabs 58, and between the side tabs 58b and the wing portions 44. The recesses 62 are aligned with the projections 48 of the leading edge 36, and are dimensioned to receive the projections 48 of another segment 24.

A plurality of the segments 24 are joined in series to form the looped track 14. The central tab 58a of a lead segment 24 receives and engages the central rod 46a of a trailing segment 24. Similarly, the two side tabs 58b of the lead segment 24 receive and engage the respective two side rods 46b of the trailing segment 24. This linking arrangement follows along the series of segments 24 to form the looped track 14.

As shown in FIG. 5, the frame 12 includes end plates 80 with elongate shaped rail extrusion sections 84 extending therebetween. The rail sections 84 extend along lateral edges of the frame 12 and are shaped to retain upper low-friction side panels 74a and lower low-friction side panels 74b, along the side edges 82 of the frame 12. The side panels 74 each include an outer surface 76 for engaging the wing portions 44 thereon. Each side panel 74 also includes a retaining channel 78 formed therein, parallel and spaced from the outer surface 76. The retaining channels 78 receive therein the retainer tabs 45 of the segments 24, thus retaining the segments 24 to the frame 12.

The drive assembly 18 comprises a motor 90 driving a drive shaft 94 via a belt and pulley assembly 92. The drive shaft 94 extends along the longitudinal direction 15 and is splined and carries spaced drive screws 96. The rotational axis of the drive shaft 94 is thus parallel to the longitudinal direction 15. The drive screws 96 each have a helical groove 97 formed at an outer surface thereof. The drive shaft 94 with the drive screws 96 extending along the longitudinal direction 15 are disposed such that the helical grooves 97 engage a lower portion of the central rods 46a of the segments 24 at the upper running surface portion 134 of the track 14. The central rods 46a thus define spaced lower engagement means 49 for the drive assembly 18, in this embodiment the spaced lower engagement means 49 being evenly spaced parallel rods 46a disposed below the upper surface 34. In this manner, rotation of the drive shaft 94 with the drive screws 96 (via the motor 90) is translated to movement of the segments 24 along the longitudinal direction 15 generally between the end plates 80 of the frame 12. Alternatively, the drive screws 96 can be a single piece drive screw extending the length of the drive shaft 94.

Each conveyor assembly 10 is a discrete independently driven unit with an upper portion (running surface 102) of the conveyor track 14 in a planar orientation for conveying items thereon in use. A lower portion (return 104) of the conveyor track 14 extends under the upper portion 17.

The embodiments of the present invention provide a linked belt design for transferring rotational power from a driving source to a linear travel output. The belt comprises flexible links guided in a restrained track, engaged with a rotating spiral screw mechanism attached to a driving force. The linked belt offers a flexible and efficient solution for transferring rotational power and can be used in various applications such as conveyors, moving sidewalks, and automation drive systems. This patent application claims the linked belt design and its use in transferring rotational power and specific applications.

A linked belt design for transferring rotational power from a driving source to a desired linear travel output is disclosed in the embodiments described. The linked belt comprises a series of interconnected links, each equipped with a hinge body that allows for bending and flexibility. The hinge bodies are guided within a restrained track to ensure consistent engagement with the rotating spiral screw mechanism, which acts as the driven component that transfers rotational power to the screw.

In the embodiments shown, the spiral screw mechanism is attached to a driving force, such as a motor, generating the rotational motion necessary to drive the screw. The spiral screw mechanism can comprise one or multiple driving screws across the belt's width. Furthermore, a driving source can be at either end, both ends, or at an intermediary position along the length of the belt.

The flexible and dynamic nature of the belt links enables them to adjust and adapt to any changes in the belt travel direction based on the position of the screw, ensuring the consistent and accurate transmission of rotational power.

The linked belt design offers a flexible and efficient solution for transferring rotational power, offering advantages over traditional sprocket and pulley drive systems. The linked belt design can be used in automation for conveyor systems, moving sidewalks, or drive systems.

The preferred embodiments provide the linked belt design, a method of transfer of rotational power, and use in specific applications.

### Advantages

The invention in a preferred embodiment provides a linked belt design for transferring rotational power from a driving source to a desired linear travel output, comprising:
a. a series of interconnected links, each with a hinge body that allows for bending and flexibility;
b. a restrained track for guiding the hinge bodies of the links;
c. a rotating spiral screw mechanism attached to the hinge bodies of the links, acting as the driven component that transfers rotational power to the screw;
d. a driving force such as a motor for rotating the belt and generating the rotational motion necessary to drive the screw.

In another preferred embodiment, the spiral screw mechanism comprises one or multiple driving screws across the belt's width.

In another preferred embodiment, the flexible and dynamic nature of the belt links enables them to adjust and adapt to any changes in the orientation or position of the screw, ensuring the consistent and accurate transmission of rotational power.

The embodiments also provide a method of transferring rotational power from a driving source to a desired linear travel output using the above linked belt design, comprising:
a. connecting the driving source to the rotating spiral screw mechanism;
b. rotating the belt using the driving source;
c. transmitting rotational power from the rotating belt to the rotating spiral screw mechanism;
d. generating linear travel output from the rotating spiral screw mechanism.

The linked belt design can be used in conveyor systems, moving sidewalks, or drive systems for automation.

The preferred embodiment provides a conveyor assembly comprising: a spiral worm drive configured to transfer rotational power, and a linked belt having a plurality of interconnected links, wherein the spiral worm drive engages with the linked belt to transfer rotational power.

In the preferred embodiment, the linked belt is configured to accommodate directional changes without requiring tensioning and alignment mechanisms.

In the preferred embodiment, the linked belt comprises a plurality of modular segments, each segment including at least one interlocking connection to a parallel segment.

In the preferred embodiment, the interlocking connection between adjacent segments comprises a male connection portion and a female connection portion that allows for easy assembly and disassembly of the linked belt.

In the preferred embodiment, the spiral worm drive can be configured to absorb vibrations during operation.

In the preferred embodiment, the conveyor assembly comprises a motor for providing rotational power to the spiral worm drive.

In the preferred embodiment, the motor in the embodiment is an electric motor, and the conveyor assembly further includes a control system configured to control the speed and direction of the motor. This allows the track to be moved in the opposite direction.

In the preferred embodiment, the linked belt includes a plurality of load-bearing members for carrying objects.

In the preferred embodiment, the linked belt in the embodiment is made of a low-friction material to minimize wear and energy loss during operation, such as a nylon material belt segment running over an Ultra-High Molecular Weight Polyethylene (UHMW-PE).

In the preferred embodiment, the conveyor assembly comprises a support frame for mounting the spiral worm drive and linked belt.

In the preferred embodiment, the support frame is adjustable in height to accommodate various applications.

In the preferred embodiment, the linked belt can be configured for low-profile applications.

In the preferred embodiment, the spiral worm drive is configured to provide a variable linear travel output depending on the input rotational speed of the motor.

In the preferred embodiment, the linked belt and the spiral worm drive are enclosed within a protective housing.

In the preferred embodiment, the protective housing comprises an ingress protection rating to prevent dust, debris, and moisture from entering the conveyor assembly, for use in outdoor or indoor operation.

In the preferred embodiment, the conveyor assembly preferably further comprises a tensioning mechanism to adjust the tension of the linked belt.

In the preferred embodiment, the spiral worm drive can be configured to operate in a range of environmental conditions, including extreme temperatures and high humidity levels due to the combination of hard-wearing industrial plastics and non-ferrous metal components.

In the preferred embodiment, the linked belt can be made of corrosion-resistant injection moulded plastic, which can also offer a non-slip surface in the design feature of the mould.

In the preferred embodiment, the linked belt can be configured for use in a vertical orientation.

The invention also provides a method of transferring rotational power to linear travel output, the method comprising: providing a conveyor assembly consisting of a spiral worm drive and a linked belt having a plurality of interconnected links; engaging the spiral worm drive with the linked belt; and transferring rotational power from the spiral worm drive to the linked belt to provide linear travel of the belt track assembly.

The present invention relates to an “Integrated Perpendicular Direct Drive System”, so named due to the direction of motion of the driving components being perpendicular to the direction of conveyor belt travel and driving the belt through direct contact. In this system all driving mechanisms are located inside the conveyor body area. This addresses the limitations of “parallel shaft drive systems” and can create a wider driving belt to the overall conveyor assembly width by eliminating the need for space to accommodate drive mechanisms. It can also reduce the overall height profile due to not needing drive sprockets and idler pulleys.

By incorporating this “Integrated Perpendicular Direct Drive System”, the conveyor belt can be broader than in conventional designs, thus giving a more significant percentage of traction area. Furthermore, eliminating driving rollers and idler pulleys can allow for a more compact profile, thus creating a conveyor nearly half the height of a conventional conveyor system, leading to space savings and greater operator safety in reducing step-up and step-down distance.

Whilst preferred embodiments of the present invention have been described, it will be apparent to skilled persons that modifications can be made to the embodiments described.

The track can be replaced by a belt having the spaced engagement means at the lower surface thereof for engaging the worm drive.

The lower engagement means in another embodiment can be angled spaced projections, portions of a gear formation, or portions of a helical thread. The rods in this embodiment can form part of the hinge for the segments and the projections/formations engage the helical thread of the drive mechanism.

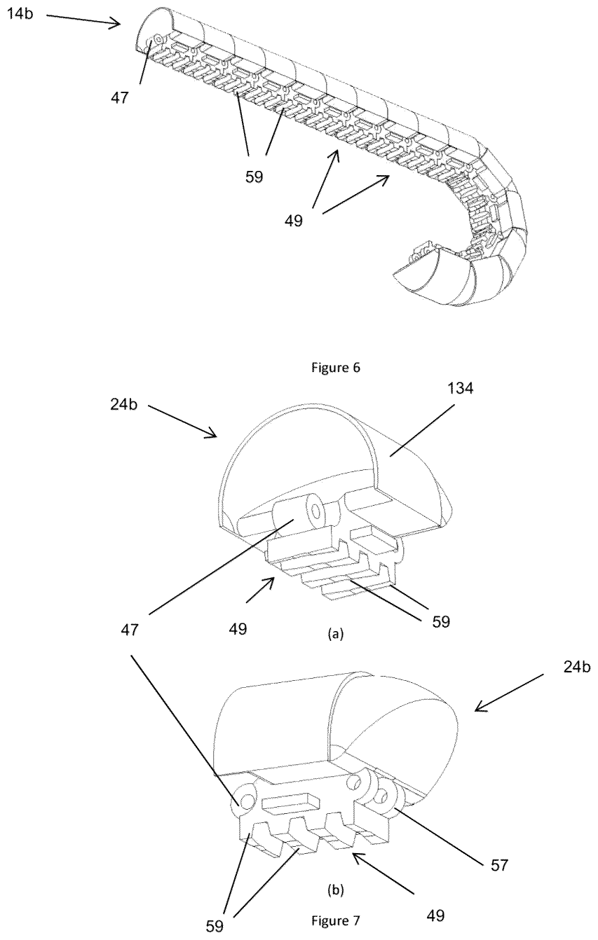

In the embodiment shown in FIGS. 6 and 7, the linked segments 24b are joined in series to form the looped track 14b.

Each segment 24b comprises a narrow body having first coupling means 47 at a leading end and corresponding second coupling means 57 at a trailing edge, the corresponding coupling means 47, 57 being for receiving a connecting rod therebetween for joining adjacent segments 24b.

The lower engagement means 49 for the drive assembly in this embodiment comprises spaced formations 59 being angled spaced projections, portions of a gear formation, or portions of a helical thread. In this manner, rotation of the drive shaft 94 with the drive screws 96 (via the motor 90) engaging the formations 59 is translated to movement of the segments 24b generally between the end plates 80 of the frame 12. The upper surface 134 in this embodiment is curved and the track 14b is narrow. This embodiment is useful for a moving handrail design, or other narrow profile conveyor.

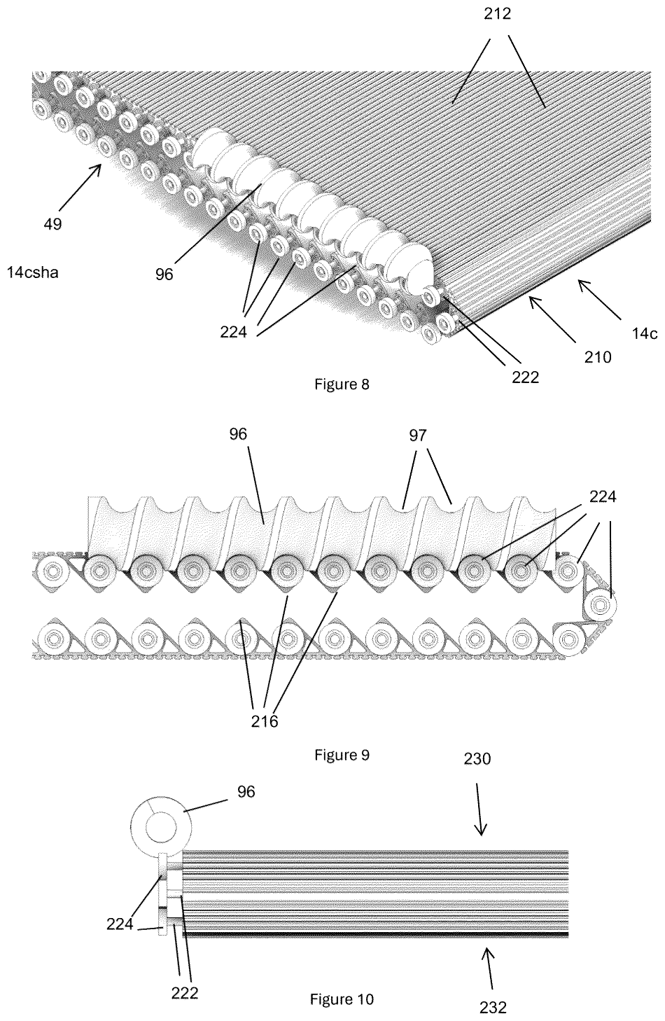

FIGS. 8 to 10 show a section of another embodiment of the conveyor track 14c with an alternative drive assembly 18 placement. The track 14c in this embodiment comprises a looped belt 210 with an engagement outer surface having spaced ribs 212. The belt 210 includes spaced formations 216 at its lower portion, the spaced formations 216 being shaped to receive a respective connecting rod 222 having a roller 224 at an outer end thereof. The rollers 224 are disposed at one lateral edge, or both lateral edges of the belt 210, in a spaced manner.

The drive screw 96 in this embodiment for the drive assembly 18 is disposed above the spaced rollers 224 at an upper portion 230 of the conveyor track 14c. A drive screw 96 can be disposed at both sides of the conveyor track 14c in the embodiment where both sides have the rollers 224. Additional drive screws 96 can also be placed to engage the rollers 224 at a lower portion 232 of the conveyor track 14c if desired.

The drive assembly 18 also comprises a motor 90 driving one or more drive shafts 94 for rotating the drive screws 96. The helical grooves 97 of the drive screws 96 engage the spaced rollers 224. The spaced rollers 224 thus define spaced engagement means 49 for the drive assembly, in this embodiment being evenly spaced rollers or cam followers for the groove 97 of the drive screw 96. In this manner, rotation of the drive shaft 94 with the drive screws 96 (via the motor 90) is translated to movement of the looped track 14c.

This embodiment provides the advantage of the upper portion 230 and the lower portion 232 of the conveyor track 14c being disposed close to each other, which provides a very low profile conveyor track.

This moves the drive to the edges of the belt, rather than in the middle, and still use the same screw drive that runs axially in the direction of belt travel.

The spaced engagement means can be roller bearings or cam follower, disposed off the lateral edges of the width of the belt. The screw drive mechanism will sit over the top of those bearing elements. Driven screws can be placed on each side of the belt link, allowing a much broader link/conveyor body to be driven with the low-profile drive mechanism.

1. A conveyor assembly, comprising:
an elongate frame having a longitudinal direction;
a looped conveyor track mounted to the frame, the conveyor track being movable along the longitudinal direction and comprising spaced engagement means; and
a drive assembly comprising a drive shaft carrying a drive screw with a helical drive formation, the drive shaft and the drive screw being oriented parallel to the longitudinal direction of the frame, the helical drive formation being for engaging the spaced engagement means of the conveyor track.

2. The conveyor assembly of claim 1, wherein the track comprises an upper surface, and wherein the spaced engagement means comprises evenly spaced parallel rods disposed below the upper surface of the conveyor track.

3. The conveyor assembly of claim 1, wherein the track is comprised of linked segments which are joined in series to form the looped track.

4. The conveyor assembly of claim 3, wherein each segment comprises an elongated body which extends laterally between side edges of the frame, the body being comprised of a flat upper surface, a leading edge, a trailing edge and side edges, the leading edge being comprised of a first coupling means, and the trailing edge being comprised of a second coupling means to join with first coupling means of an adjacent trailing segment.

5. The conveyor assembly of claim 4, wherein the first coupling means comprises at least one rod which extends parallel to the lateral direction of the body.

6. The conveyor assembly of claim 5, wherein the first coupling means comprises a central rod which defines the lower engagement means of the track.

7. The conveyor assembly of claim 5, wherein the first coupling means comprises two side rods at either side of the central rod.

8. The conveyor assembly of claim 5, wherein the second coupling means comprises at least one trailing tab which corresponds and hingedly attaches with the rod of the leading edge.

9. The conveyor assembly of claim 4, wherein each segment comprises a central portion and wing portions extending laterally outwards from the central portion, the wing portions to rest on and slide along low friction side panels of the frame.

10. The conveyor assembly of claim 1, wherein the frame further comprises end plates with elongate shaped rail sections extending therebetween, the rail sections having upper low-friction side panels along side edges of the frame.

11. The conveyor assembly of claim 1, wherein the drive assembly comprises a motor driving a drive shaft, the drive shaft carrying at least one drive screw which has a helical groove formed at an outer surface, and wherein the drive screw engages the spaced engagement means of the track.

12. The conveyor assembly of claim 1, wherein the spaced engagement means comprises angled spaced projections, portions of a gear formation, or portions of a helical thread to engage the helical drive formation of the drive assembly.

13. The conveyor assembly of claim 1, wherein the track comprises lateral edges, and wherein the spaced engagement means comprises evenly 9 spaced rollers or cam followers disposed adjacent at least one of the lateral edges.

14. The conveyor assembly of claim 13, wherein the track is comprised of a lower portion with spaced formations, the spaced formations being shaped to receive a respective connecting rod having the roller or cam follower at an outer end thereof.

15. The conveyor assembly of claim 13, wherein the drive shaft and the drive screw are disposed above the spaced engagement means at an upper portion of the conveyor track.
